(19) United States
(12) Patent Application Publication
(10) Pub. No.: US 2023/0110373 A1
(43) Pub. Date: Apr. 13, 2023

(54) MODULAR FARM PICKUP, BULK TRANSPORT, AND DIRECT SHIP CABINET SYSTEM FOR PERISHABLE LIQUIDS

(71) Applicant: Thomas John Hitchcock, Edgerton, WI (US)

(72) Inventor: Thomas John Hitchcock, Edgerton, WI (US)

(21) Appl. No.: 17/960,463

(22) Filed: Oct. 5, 2022

Related U.S. Application Data
(60) Provisional application No. 63/253,470, filed on Oct. 7, 2021.

(51) Int. Cl. B67D 7/02; B67D 7/58; B60P 3/22

(52) U.S. Cl. CPC B67D 7/0294; B67D 7/58; B60P 3/225

(57) ABSTRACT

The present invention relates a modular cabinet system for attaching to truck or truck trailer combinations involved in the loading and unloading of comestible liquid products transferred in bulk from one or more production site(s) to one or more processing center(s) or end users. The cabinet system is installed onto the rear of the transport vehicle and over the outlet valve of the transport vehicle such that the valve of the transport vehicle is enclosed within the cabinet system. The cabinet system transforms the transport vehicle such that the transport vehicle can load and unload comestible liquid products from any site regardless of the facilities and equipment provided at the site without the need to modify and reconfigure pumping and or other aspects of the cabinet system based on the site. The cabinet system includes at least a pump compartment with a dock mating surface that is enclosed by a moveable door and a separate motor compartment also enclosed by a moveable door. The cabinet system is configurable to comply with applicable regulations and requirements including 3-A standards, when necessary.

### CROSS-REFERENCE TO RELATED APPLICATIONS

The present application claims priority of U.S. Provisional Patent Application No. 63/253,470, filed Oct. 7, 2021, the content of which is incorporated herein by reference in its entirety.

### FIELD OF THE INVENTION

The present invention relates a cabinet system for semi-trailers/tractor trailers involved in loading, transport, and unloading of perishable liquids.

### BACKGROUND

The pickup, transport, and drop-off of perishable liquids like milk, is an important and highly regulated process to ensure the safety of the product. Comestible liquid products transferred in bulk from one or more production site(s) to one or more processing center(s) or end users is accomplished by a variety of specialty truck or truck trailer combinations (transport vehicle) configured to receive, store, and offload comestibles in a safe manner complying with applicable regulations.

Commonly in the dairy industry a farm/hauling operation must have multiple pieces of equipment (transport vehicles) to accommodate different farm sizes, locations, and delivery requirements. Two standard designs are a Farm Pick Up vehicle which typically picks up multiple small loads from smaller farms and drops them at a processing center. Smaller farms generally do not have enough product to fill an entire vehicle and typically do not supply the needed pumping/equipment for procuring the product. The other is a transport or Direct Ship unit that is typically filled completely at a single farm and transports the load to processing. While it seems typical that a smaller farm or production facility may not provide pumping/other necessary equipment, any procurement site or processing site may have different levels of on-site pumping/equipment capabilities.

Comestibles have varying requirements to maintain product safety. One such regulating document is the Pasteurized Milk Ordinance (PMO). The PMO makes reference to 3-A Sanitary Standards and Bulk tankers. The 3-A Sanitary standard (05-16) establishes the criteria for Automotive Transportation Tanks for Bulk Delivery and Farm Pick-Up Service. The 3-A Sanitary Standards essentially require that the milk hose connection to the milk tank truck be completely protected from the outside environment at all times. However, the PMO does not regulate facility requirements at production sites or processing centers. It is the transport operator's responsibility to ensure that the 3-A Sanitary Standards are met when picking up and dropping off the comestible.

Since the 3-A Sanitary Standards do not specifically prescribe facility requirements at production sites and processing centers (sites), and since each production site and processing center is different, this has led to a variety of designs and equipment at facilities. Some sites (production or processing) may provide pumping capabilities on site that comply with the 3-A standards, some sites may not have any pumping capabilities, some sites may provide a docking station to facilitate complying with the 3-A standards, while other sites may not provide any special equipment or facilities to facilitate compliance with the 3-A standards. This variety of site facilities and equipment has created the need for a variety of transport vehicles to procure and offload comestibles, to wit: bulk transport vehicles, farm pickup vehicles, and direct ship vehicles. Each type of vehicle has different advantages/disadvantages and is equipped to procure/offload comestibles from at least one or more of the variety of sites, but none of these vehicles is equipped and well configured to procure/offload comestibles from all types of sites.

Bulk transport vehicles are the simplest and most economical of liquid collection vehicles. Bulk transport vehicles require an outlet valve with a sanitary cap over the outlet opening. The outlet valve must be enclosed in a dust cover that is dust proof and a sealing mechanism that prevents the sanitary cap from opening or being removed without breaking the seal. Bulk transport vehicles can technically be used at any pickup facility or destination facility provided the facility has its own pumping mechanism and shore equipment (such as fittings, adapters, gaskets, etc.) as the bulk transport vehicle does not have a pump or short equipment. Further, the operator of a bulk transport vehicle has the most hands on responsibility in ensuring that the cleanliness and sanitary standards are followed because the bulk transport vehicle does not any structure to assist in the provision of a sanitary environment. Additionally, sites may require the transport vehicle to have equipment matching the facilities provided. For example, while a bulk transport vehicle may technically be able to pick-up or drop-off at a site that has a loading dock, the site might not allow transport vehicles that are not able to mate with the loading dock. Bulk transport vehicles cannot mate with docking stations and cannot pickup or drop off from sites that do not provide pumping and shore equipment.

Farm pickup vehicles include pump and shore equipment and comply with 3-A standards for onboard pump and shore equipment. Farm pickup vehicles can technically load and unload at any site however the vehicle cannot mate with a docking station, as farm pickup vehicles do not include a dock mating surface for mating with a docking station.

Direct ship vehicles include a dock mating surface for mating with a docking station. However, direct ship vehicles do not include pump and shore equipment. Therefore, direct ship vehicles can only load and unload at sites that provide pump and shore equipment.

While owning one or more of each of the above vehicles would allow an operator to procure and offload at all sites, an operator would need to own at least one direct ship and at least one farm pickup vehicle in order to accommodate the variety of on-site facilities provided at each site. In today's world of consolidation and cooperatives there is a decrease in smaller farms and an increase in larger and cooperative farms. This has placed a strain on the farms/haulers with increasing needs for variable equipment. Therefore, it is an expensive proposition for a hauler to own enough vehicles to be able to pick-up and drop-off at all sites. Further complicating matters is the need to coordinate the vehicle used for pick-up with the desired drop-off facility. For example, a direct ship vehicle can pick-up from a site that provides pumping equipment, but then could not drop off at a facility that does not also have the proper equipment for unloading, whereas the farm pick-up vehicle would be able to drop-off at that facility.

### SUMMARY OF THE INVENTION

It would be desirable to have a single transport vehicle capable of procurement and offloading at any of the variety of sites. It is further desirable to have a single transport vehicle configured to perform pickup, transport, and drop-off of comestibles that meets all applicable design and regulatory requirements regardless of the facilities and equipment provided at a site that does not require operator manipulation and reconfiguration of the vehicle. It would further be desirable to use a standard comestible truck or truck trailer with a rear surface outlet valve to procure, transport, and offload the comestibles that can be outfitted to have a cabinet system affixed to the rear of the transport vehicle accommodating for the outlet valve such that the cabinet system provides the ability for the transport vehicle to procure and offload comestibles at all production and processing sites regardless of the facilities and equipment provided by the sites. This would allow for retrofitting existing comestible transport vehicles and for removal of the cabinet system if it is no longer needed.

Accordingly, an ideal transport vehicle may be a standard liquid comestible transport vehicle with an outlet valve located on the rear of the vehicle with a cabinet system affixed to the rear of the vehicle such that the outlet valve is encompassed and enclosed by the cabinet system.

The ideal cabinet system will be configured to comply with the design requirements based on all of the variety of production and processing sites regardless of the facilities and equipment provided by each site without the need to adapt or modify the cabinet system at each site. In applicable circumstances the cabinet system will comply with all A-3 standards applicable for all production and processing sites regardless of the facilities and equipment provided at each site. The cabinet system would include onboard pumping mechanisms and equipment in a manner that complies with the A-3 standards in a pump compartment, a separate operation/motor compartment that complies with A-3 standards, and a dock mating surface enclosed within the pump compartment such that when the door/doors of the pump compartment are opened the dock mating surface protrudes from the rear of the body of the pump compartment sufficiently to mate with and releasably seal to the cushions of a docking station without damaging the pump compartment or pump compartment door/doors.

In some aspects, the techniques described herein relate to a cabinet system configured to affix or releasably affix to a rear surface of a transport vehicle with a rear outlet valve such that the rear outlet valve is encompassed and enclosed within a body of the cabinet system. The cabinet system comprises a pump compartment and a motor compartment. The pump compartment, including: a top surface, a bottom surface, two substantially parallel opposing side surfaces, wherein one of the substantially parallel opposing side surfaces includes a side surface cutout to accommodate a pump connection to a motor in a motor compartment, a back surface with a cutout to accommodate the rear outlet valve of the transport vehicle, and a front surface, including a dock mating face that is a substantially open frame providing access to an interior of the pump compartment, wherein the interior of the pump compartment is covered and sealed by a moveable pump compartment door that when open provides access to the interior of the pump compartment, further wherein the dock making face is configured to mate with a docking station. The motor compartment, including: a top surface, a bottom surface, two substantially parallel opposing side surfaces, wherein one of the substantially parallel opposing side surfaces includes a cutout corresponding to the side surface cutout in the pump compartment to accommodate the pump connection to the motor in the motor compartment, a back surface, and a front surface, wherein the front surface of the motor compartment is substantially open to provide access to the interior of the motor compartment, further wherein the front surface of the motor compartment is covered and sealed by a moveable motor compartment door that when open provides access to the interior of the motor compartment. The motor compartment is affixed to one side surface of the pump compartment with the side surface cutout.

In some aspects, the techniques described herein relate to A cabinet system configured to affix or releasably affix to a rear surface of a transport vehicle with a rear outlet valve such that the rear outlet valve is encompassed and enclosed within a body of the cabinet system. The cabinet system comprising a pump compartment. The pump compartment, including: a top surface, a bottom surface, two substantially parallel opposing side surfaces, a back surface with a cutout to accommodate the rear outlet valve of the transport vehicle, and a front surface, wherein the front surface is an opening, a dock mating face attached to the front surface of the pump compartment, wherein the dock making surface forms a substantially open frame providing access to an interior of the pump compartment, further wherein the dock making face is configured to mate with a docking station; and a moveable pump compartment door attached to the dock mating face, wherein the interior of the pump compartment is covered and sealed by the moveable pump compartment door when closed and that when open provides access to the interior of the pump compartment.

This new design allows, for the first time, a single piece of equipment to be used for all perishable/milk hauling applications without the need to change, alter or remove parts.

There are several advantages to the cabinet system for the liquid comestible transport vehicle. The cabinet system is configured and equipped to procure and offload liquid comestibles in compliance with A-3 standards regardless of the facilities and equipment provided at the site. Further the cabinet system is configured to and equipped to work with all sites without the need to modify or manipulate the vehicle to accommodate different site facilities. This means that an operator only needs a single transport vehicle for procuring and offloading liquid comestibles at all sites. This eliminates the need for an operator to own several different vehicles to accommodate for different facilities at each site and expands the operator's ability to procure and offload at any site. Further the cabinet can be permanently or semi-permanently affixed to a standard liquid comestible transport vehicle which is the most economical of liquid comestible transport vehicles, allowing currently owned transport vehicles to be retrofitted with the cabinet system.

### BRIEF DESCRIPTION OF THE DRAWINGS

FIG. 1 illustrates an exemplary embodiment of a partial rear view of a perishable liquid semi-trailer with an exemplary embodiment of the cabinet system affixed to the rear of the semi-trailer.

FIG. 2 illustrates an exemplary embodiment of a partial perspective font view of a pump compartment with top of dock mating surface removed for visual clarity.

FIG. 3 illustrates an exemplary embodiment of a partial perspective rear view of a pump compartment with top of dock mating surface removed for visual clarity.

FIG. 4 illustrates an exemplary embodiment of a perspective front view of a cabinet system with a pump installed.

FIG. 5 is a picture of an exemplary embodiment of the interior of a motor cabinet with a motor installed.

FIG. 5A illustrates an exemplary embodiment of a perspective front view of a motor compartment to be attached to the right side of a pump compartment.

FIG. 5B illustrates an exemplary embodiment of a perspective front view of a other compartment to be attached to the right side of a pump compartment.

FIG. 6 illustrates an exemplary embodiment of a perspective front view of a cabinet system.

FIG. 7 illustrates an exemplary embodiment of a perspective rear view of a cabinet system.

FIG. 8A illustrates an exemplary embodiment of the interior view of a pump compartment door for a double door configuration.

FIG. 8B illustrates an exemplary embodiment of the exterior view of a pump compartment door for a singular door configuration.

FIG. 8C illustrates an exemplary embodiment of the interior view of a pump compartment door for a singular door configuration.

FIG. 9 illustrates an exemplary embodiment of a reinforced top surface of a cabinet system.

### DETAILED DESCRIPTION OF THE INVENTION

In some aspects, the devices and techniques described herein relate to a cabinet system and device for use in procuring and offloading liquid comestibles into and out of a liquid comestible truck or truck trailer (transport vehicle). Embodiments of the cabinet system are illustrated in the figures. It should be understood that dimensions and description in the figures are merely exemplary and are to aid in the understanding of the system. Dimensions and description included in the figures should not be considered limiting in any way. It should be understood that while the cabinet system is described herein with specific reference to milk, the cabinet system may be incorporated for use with other liquid comestible products and other liquid non-comestible products. The depictions of the exemplary embodiments of the cabinet system should not be in any way considered limited to milk products or to any single particular configuration.

The modular cabinet system will allow for a single transport vehicle to load and unload perishable liquids from all sites regardless of the equipment and facilities provided at the sites while still complying with all applicable standards and regulations for the loading and unloading of said liquids. Further the modular cabinet system will not require any pumping or structural reconfiguration or modification to function at any site.

The modular cabinet system can be configured with insulation for temperature sensitive operations on a compartment-by-compartment basis as needed. Further, the optional double sealed pump compartment doors aid in temperature control and sterility requirements.

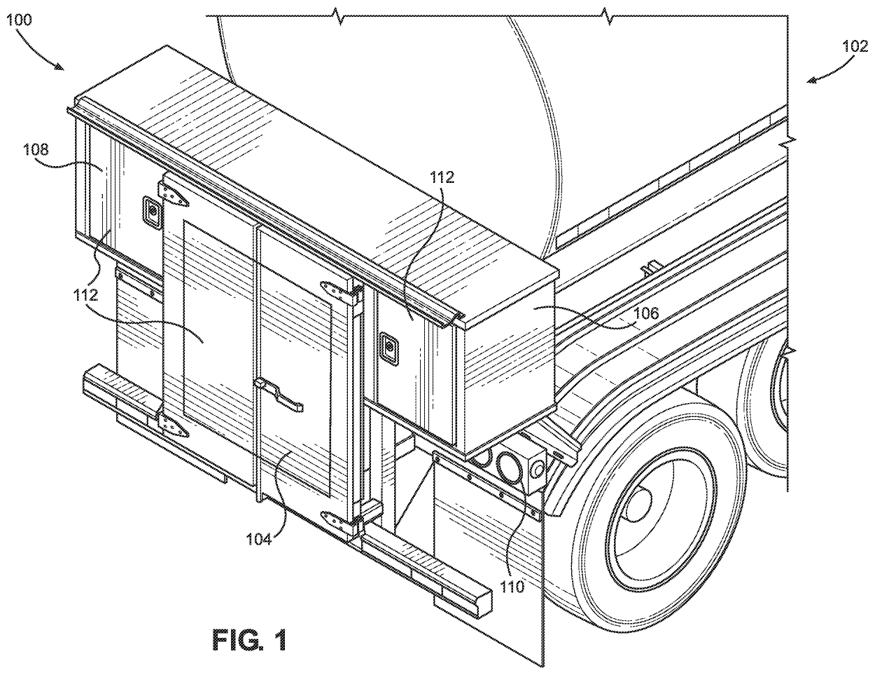

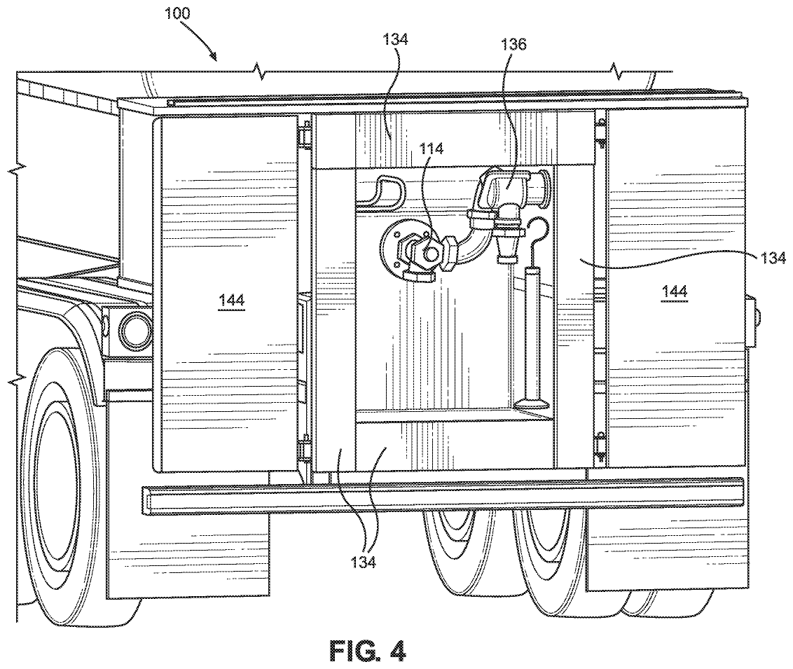

Referring to FIG. 1, the cabinet system 100 is affixed (permanently or semi-permanently) to at least a portion of the rear surface of a transport vehicle 102 such that the outlet valve 114 of the transport vehicle (shown in FIG. 4) is enclosed within the cabinet system. The cabinet system 100 may be attached to the rear of the transport vehicle 102 in any known manner such that the cabinet system 100 is permanently or semi-permanently affixed to the transport vehicle (e.g., welded, bolted, etc.). In an embodiment, the cabinet system 100 will attach to the transport vehicle 102 such that when on level ground, the cabinet system 100 will be situated to be level with the ground; however, this is not essential for the proper function and use of the cabinet system 100.

Referring to FIG. 1 the cabinet system 100 includes at least two rectangularly shaped compartments: the pump compartment 104 and the motor compartment 106. As shown in FIG. 1 the cabinet system 100 may include more than two compartments, it may include other compartments 108. The cabinet system 100 may be manufactured to be a singular system with all compartments permanently affixed to each other. Alternatively, the cabinet system 100 may be modular such that the pump compartment 104 is the base compartment and the motor compartment 106 can be added to either side of the pump compartment 104 and additional compartments 108 may be added to the side of the pump compartment 104 not attached to the motor compartment 106. Further, it should be understood that while the motor compartment 106 and other additional compartments 108 are illustrated in FIG. 1 as vertically shorter than the pump compartment 104, this is not a requirement. The motor compartment 106 and other compartments 108 may be of varying size provided they do not exceed the horizontal width of the transport vehicle 102 or extend below the rear bumper 110 of the transport vehicle 102 when configured with the pump compartment 104. Further, while the figures only illustrate a pump compartment 104, a motor compartment 106, and one other compartment 108, it should be understood that depending on the sizing of the motor compartment 106 and the other compartment 108, the cabinet system 100 may include additional other compartments 108. Further, the motor compartment 106 and other compartments 108 may be subdivided within the respective compartment (not shown). While the motor compartment 106 is shown in the figures to be on the right side of the pump compartment 104, it should be understood that is merely for depiction and the motor compartment 106 could also be on the left side of the pump compartment 104. Materials for manufacturing the cabinet system include, but are not limited to, any stainless steel or metal alloys that, under normal use and when exposed to the conditions encountered in the environment of their intended use, including cleaning, sanitizing treatment, and/or sterilization, are found to have acceptable corrosion resistance (e.g., stainless steel type 304). Plastics and aluminum alloys are also acceptable options. The cabinet system 100 can be attached to the rear of the transport vehicle 102 (permanently or semi-permanently) in any manner known in the industry.

### Pump Compartment 104:

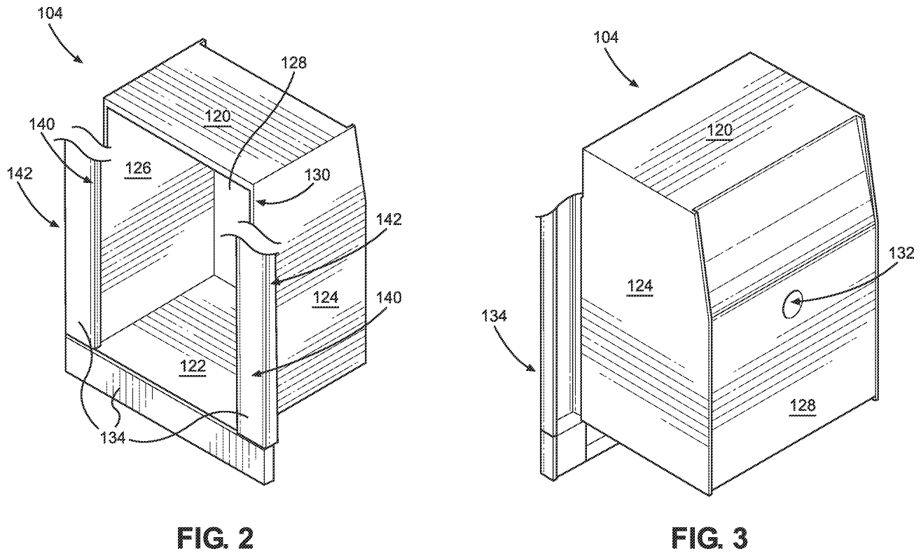

Referring to FIGS. 2-9, the pump compartment 104 is a substantially rectangular box shape cabinet. In an embodiment, the pump compartment 104 measures approximately 31″ wide by 44″ tall by 26″ deep (alternate standard size is 37″ wide by 44″ tall by 26″ deep). The pump compartment 104 houses the pump, hoses, fittings, sampling tools and other sanitary equipment needed to pickup/drop-off comestible liquid produces at and to sites that do not provide their own pumping capabilities. It should be understood that other sizes and shapes of the pump compartment 104 are contemplated. For example, the above sizes are based on chassis widths of the transport vehicle 102, which could change over time. It is contemplated that the pump compartment 104 is adaptable to accommodate different chassis widths. It is further contemplated that the pump compartment 104 size could be reduced such that it is able to fit the minimum size pump and equipment needed. It is further contemplated that the pump compartment 104 could be expanded to cover the non-motor compartment side of the chassis of the transport vehicle 102. The only size constraints on the pump compartment 104 is the chassis width of the transport vehicle 102, the amount of equipment required for the pump compartment 104, and that there be sufficient space for the motor compartment 106.

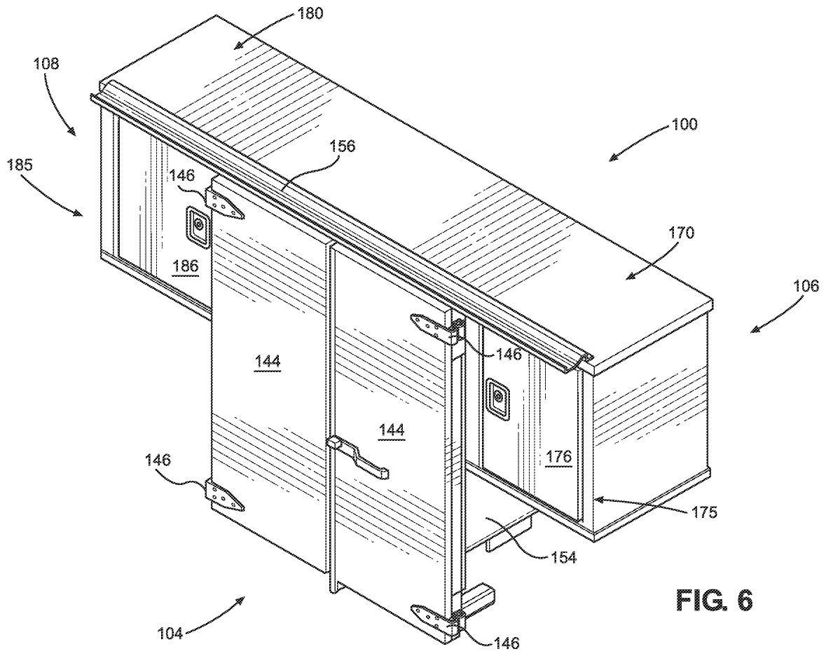

As shown in FIGS. 2-4, the pump compartment 104 is manufactured and configured to include a dock mating surface 134 as part of an outward facing surface 130 of the pump compartment 104 and pump compartment door(s) 144 (embodiment shown in FIGS. 4 and 6). The pump compartment 104 complies with the 3-A standards. These standards include, but are not limited to, that the lining of the cabinet, doors, and faxed attachments must be smooth; all permanent metallic joints in the lining shall be continuously welded and all welded areas in the shall be at least as smooth as the adjoining surfaces; all plastic material, if used, shall be fabricated so that all joints are welded, bonded, or permanently sealed to be watertight and as smooth as the adjoining surfaces; the bottom shall be constructed so that it will not sag, buckle or prevent complete drainage when the truck is on a level surface; all inside corners shall have minimum radii of ⅛ in. (3.18 mm), the cabinet interior shall be dust tight and the door/doors shall be equipped with a compression type closing device; gasket material for sealing cabinet door/doors may be installed on the face of the cabinet or on doors except along a drainage area where it shall be attached to the door/doors; gasket material shall be removable or firmly bonded to provide smooth, easily cleanable surfaces without crevices; a roof overhang or suitable drip molding shall be provided over the cabinet doors; a carrier bracket shall be provided to support the flexible transfer tubing; means shall be provided to support the loose end of the tubing above the cabinet floor; fixed attachments such as pump support brackets, tubing carrier brackets and brackets for belt and pulley guards shall be easily accessible for cleaning; the size and location of the cabinet shall be such that will afford easy accessibility for assembly and disassembly of removable parts and provide ample clearance around permanently installed equipment and parts.

Referring to FIGS. 2 and 3, in general, the pump compartment 104 includes a top surface 120, a bottom surface 122 substantially parallel to the top surface, two substantially parallel side surfaces 124 and 126, an inward facing surface 128, and an outward facing surface 130 forming a rectilinear shaped cabinet. The top surface 120, bottom surface 122, inward facing surface 128, and side surfaces 124 and 126 are primarily solid panels or sheets of material permanently joined together to form the shape of a substantially rectangular box in compliance with the A-3 standards. Each surface may be an individual panel joined to the other panels or may be a one or more panels bent and joined at seams to form the prescribed shape.

The inward facing surface 128 includes a hole 132 bore in the panel sized to fit over the outlet valve 114 of the transport vehicle (shown in FIG. 4) such that the outlet valve 114 is contained within the pump compartment 104. The inward facing surface 128 of the pump compartment 104 may be flat, bent (as shown in FIG. 3) or curved to mimic and accommodate for the shape of the rear surface of the transport vehicle 102. The inward facing surface 128 of the pump compartment is attached and affixed to the rear surface of the transport vehicle 102 in a permanent or semi-permanent manner.

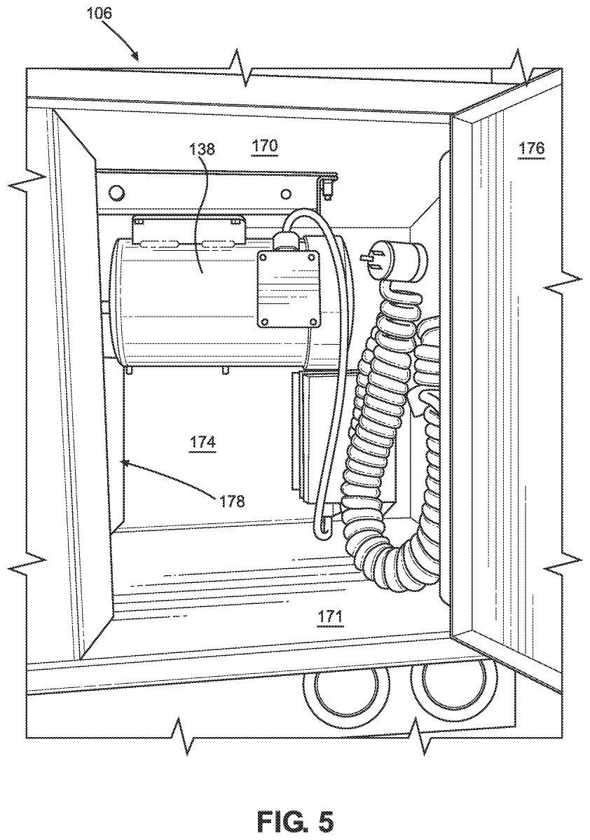

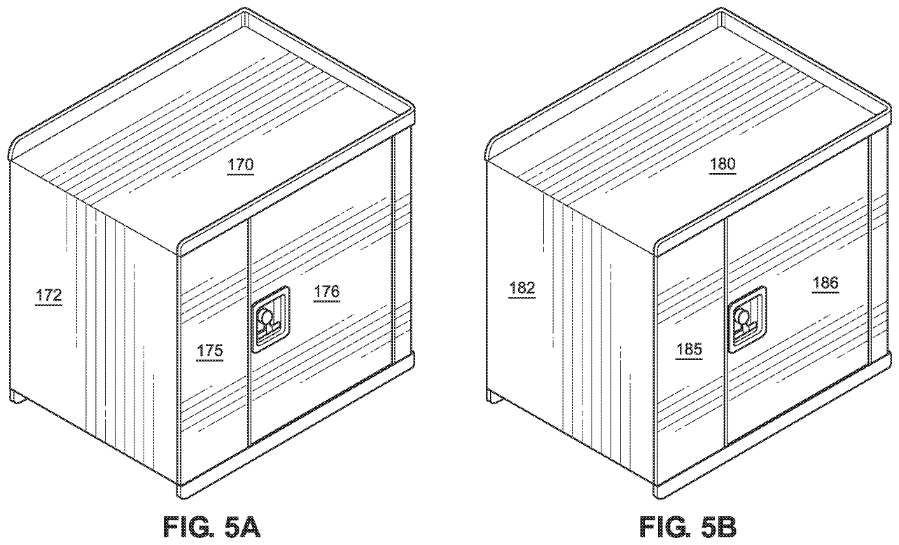

It should be understood that the side surfaces 124 and 126 will be shaped and structured to join with the shape of the inward facing surface 128 (as show in FIGS. 2 and 3 for example). One of the side surfaces 124 or 126 will also have a hole bore in it for attaching the pump 136 (shown in FIG. 4) (which is contained in the pump compartment 104) to the motor 138 (which is contained in the motor compartment 106) (shown in FIG. 5). Given the variety of pumps, piping, and side to which the pump is installed, the pump compartment 104 may be constructed with fully solid panels or sheets of material and the holes for the pump 136 and/or piping and/or the outlet valve 114 may be created at installation rather than pre-cut in the panels. However, if the configuration is known at the time of manufacture of the pump compartment 104, the hole(s) can be pre-cut at the time of manufacture. A bolting flange is typically incorporated with the pump 136 to complete the mounting; however, any mounting known in the industry may be utilized.

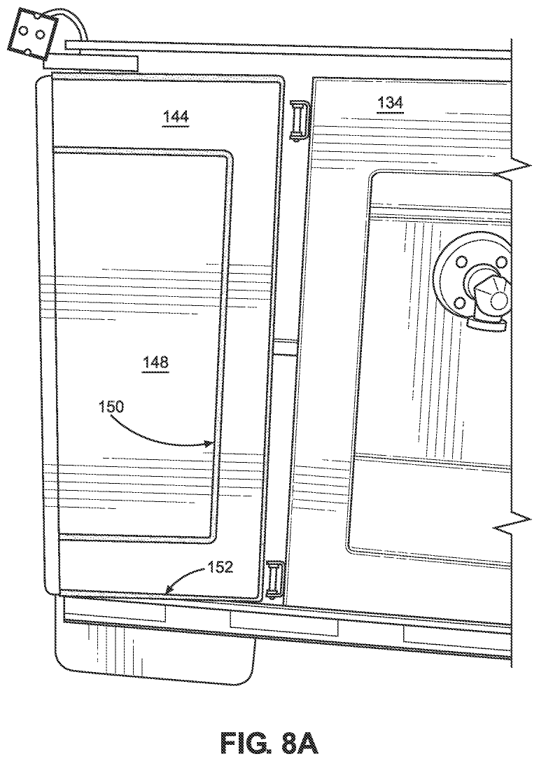

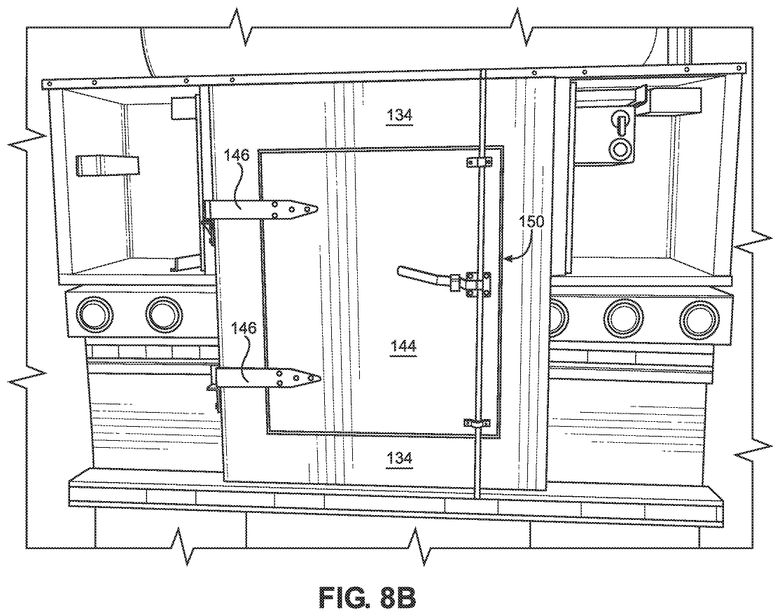

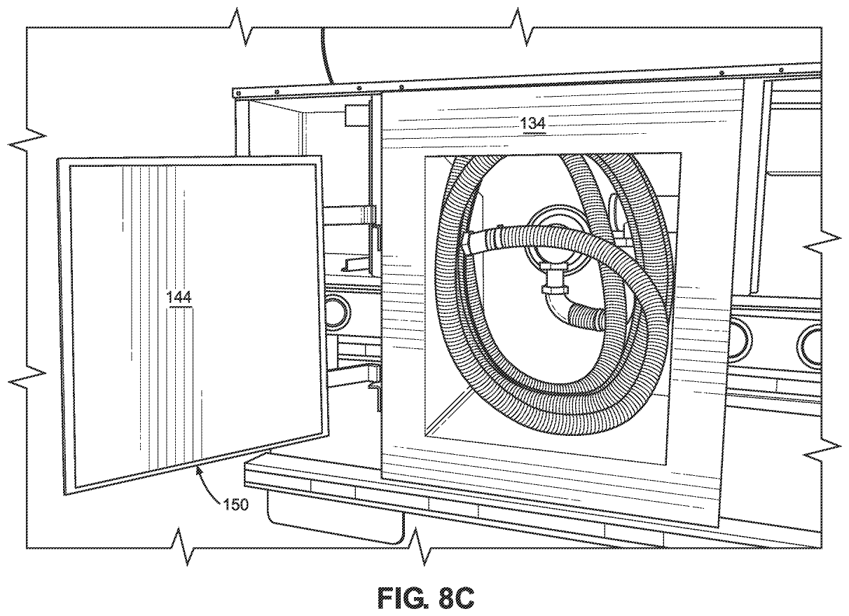

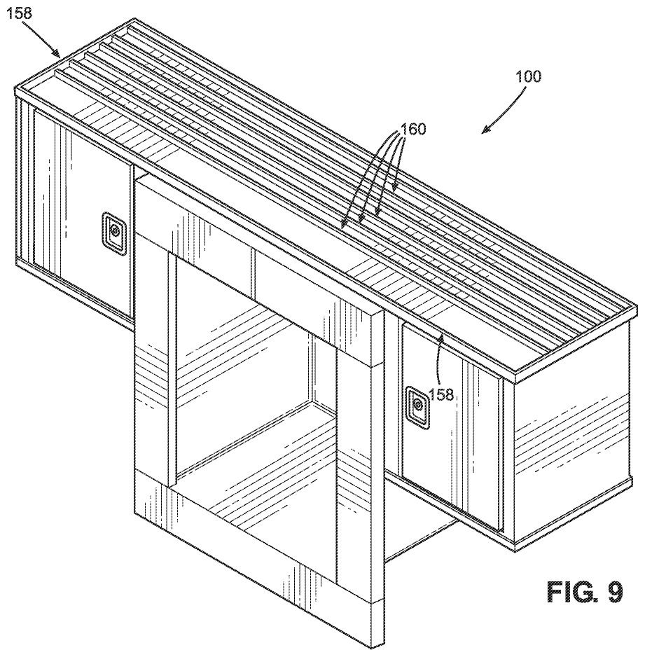

Referring to FIGS. 2, 4, and 6, the outward facing surface 130 of the pump compartment 104 is substantially open for access to the interior of the pump compartment 104 and includes a dock mating surface 134 and pump compartment door(s) 144. The dock mating surface 134 is a flat rectangular surface shaped like a frame with the interior of the frame open to the interior of the pump compartment 104. In an embodiment, when in the closed position, the pump compartment door(s) 144 cover the dock mating surface 134 and the interior of the pump compartment 104 (e.g., see FIG. 6). In an embodiment, when in the closed position, the pump compartment door(s) 144 do not cover the dock mating surface 134, but just cover the interior of the pump compartment 104 (e.g., see FIG. 8B).

The dock mating surface 134 is configured to mate with and releasably seal with the compression cushions of standard docking stations for liquid comestibles (not shown), which are known in the art. The dock mating surface may be constructed out of the same material as the rest of the pump compartment 104 or may be constructed out of any steel, aluminum alloy or plastic material capable of withstanding the forces exerted during the docking process. In an embodiment, the dock mating surface 134 measures approximately 42″ wide by 51″ tall along the exterior frame edges 142 and approximately 29″ wide by 36″ tall along the interior frame edges 140. It should be understood that the above sizes are exemplary, and standard based on the current standard for docking stations. It should be understood that the size of the dock mating surface 134 can be adapted to accommodate different docking station standards that may arise. The dock mating surface 134 is permanently attached to the top surface 120, bottom surface 122, and side surfaces 124 and 126 of the pump compartment 104. As shown in FIG. 2 the dock mating surface 134 is attached to the pump compartment with the interior frame edges 140 such that the exterior frame edges 142 extend outward from the perimeter of the pump compartment 104. However, it should be understood that the dock mating surface 134 may be attached to the pump compartment 104 at any place between the interior frame edges 140 and the exterior frame edges 142 as needed to accommodate the interior dimensions of the pump compartment 104.

The dock mating surface 134 is manufactured and configured to comply with 3-A standards as described above for the pump compartment 104 and with PMO standards for docking stations including, but not limited to, being capable of mating with a receiving/shipping dock cushion that seals at a minimum on the top and sides of the interior of the pump compartment 104 from the outside environment. The dock mating surface 134 should be smooth and free of snag points; and be of sufficient strength to prevent damage to the trailer under compression of the docking cushion.

Referring to FIGS. 4, 6 and 8B, the pump compartment door(s) 144 is/are primarily rectangular in shape and, in an embodiment, when in the closed position, completely cover and seal the entire face of the dock mating surface 134 and interior of the pump compartment 104 to meet 3-A standards as stated above. In an embodiment, when in the closed position, the pump compartment door(s) 144 do not cover the face of the dock mating surface 134 but do completely cover and seal the interior of the pump compartment 104 to meet 3-A standards as stated above. In addition, the pump compartment door(s) 144 is/are attached to the dock mating surface 134 and/or pump compartment 104 in a manner that enables the pump compartment door(s) 144 to open at least 180 degrees and are manufactured and configured to, when in the open position, have sufficient clearance from the dock mating surface 134 to not interfere with mating to a docking station and not be damaged by the compression forces exerted on the dock mating surface 134 by the docking station cushions.

As shown in FIGS. 4 and 6, in an embodiment, the pump compartment door(s) 144 are two vertically hung symmetrical doors. The pump compartment doors 144 are attached to the pump compartment 104 with proprietary side mount hinges 146 affixed to the outer side edge of the exterior frame edges 142 of the dock mating surface 134. The proprietary side mount hinges 146 are manufactured to allow the pump compartment doors 144 to swing open at least 180 degrees from the closed position and be situated, when opened, a sufficient distance horizontally back from the dock mating surface 134 to not interfere with the dock mating surface 134 when mating with a docking station and to not be damaged by the compression cushions of the docking station when mated. In an embodiment, when open, the pump compartment doors 144 rest approximately ½ inch distance horizontally back from the dock mating surface 134. It should be understood that this is merely an exemplary distance, and a sufficient distance may be as little as nearly flush. It should further be understood that a sufficient distance would be a minimum distance to provide the needed clearance for the docking process; however, in embodiments the distance could be greater. It should be understood that other embodiments of configuring and mounting the pump compartment doors 144 to the pump compartment 104 are contemplated and encompassed by this application, including, but not limited to a single door structure and alternate hinging structures, provided these configurations allow for the pump compartment door(s) 144, when closed, to enclose and seal the dock mating surface 134 and interior of the pump compartment 104 in accordance with 3-A standards and, when open, to provide sufficient clearance to not interfere with the docking process or be damaged by the docking process.

As shown in FIG. 8B, in an embodiment, the pump compartment door(s) 144 is a single vertically hung door not covering the face of the dock mating surface 134. The pump compartment door 144 is attached to the pump compartment with proprietary side mounted lift off hinges. The proprietary side mount hinges 146 are manufactured to allow the pump compartment door 144 to swing open at least 180 degrees from the closed position and be situated, when opened, a sufficient distance horizontally back from the dock mating surface 134 to not interfere with the dock mating surface 134 when mating with a docking station and to not be damaged by the compression cushions of the docking station when mated. In an embodiment, when open, the pump compartment door 144 rests approximately ½ inch distance horizontally back from the dock mating surface 134. It should be understood that this is merely an exemplary distance, and a sufficient distance may be as little as nearly flush. It should further be understood that a sufficient distance would be a minimum distance to provide the needed clearance for the docking process; however, in embodiments the distance could be greater. It should be understood that other embodiments of configuring and mounting the pump compartment door 144 to the pump compartment 104 are contemplated and encompassed by this application, including, but not limited to a double door structure and alternate hinging structures, provided these configurations allow for the pump compartment door(s) 144, when closed, to enclose and seal the dock mating surface 134 and interior of the pump When in the closed position, the pump compartment door(s) 144 may be latched and locked in any way commonly known. These embodiments should not be considered limiting.

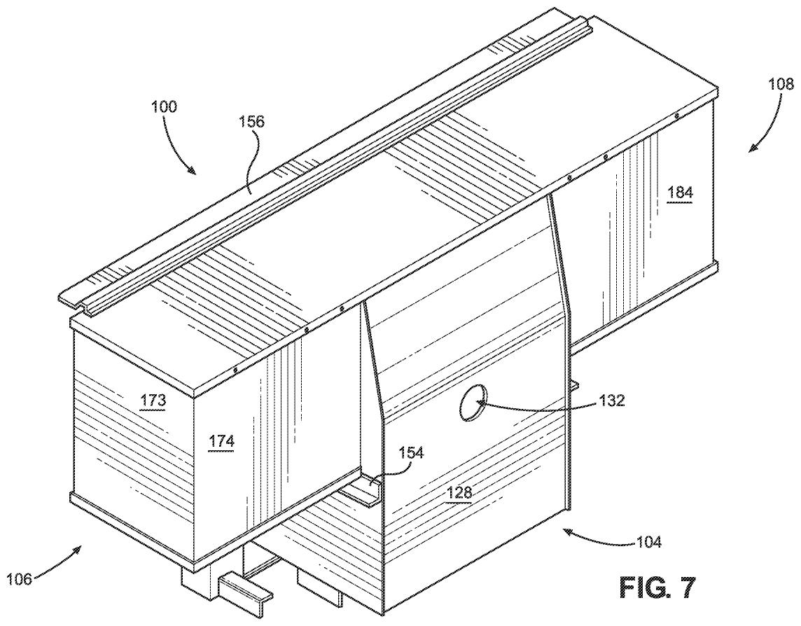

The top surface 120 of the pump compartment 104 will have a drip guard 156 movably attached (shown in FIGS. 6 and 7). When the transport vehicle 102 is not docked, the drip guard 156 may be in a position that overhangs the outward facing face of the dock mating surface 134 to prevent water and other elements from dripping into the pump compartment 104 as required by the 3-A standards. However, the drip guard 156 is movably attached to the top surface 120 of the pump compartment 104 such that when the transport vehicle 102 is docked, the drip guard 156 is moved from its position overhanging the outward facing surface of the dock mating surface 134 backward towards the rear of the transport vehicle 102 enabling the dock mating surface 134 to mate with the docking station while not damaging the drip guard 156 during the docking process. This may be accomplished by affixing the drip guard 156 to the top surface 120 of the pump compartment 104 in a hinged manner and angle such that when the drip guard 156 begins to encounter the cushions of the docking station the cushions cause the drip guard to move about the hinges and move toward the rear of the transport vehicle 102 and away from the docking station. In another example, the drip guard 156 may be non-movably attached to the top surface 120 of the pump compartment 104 and be made of a material sufficiently flexible and be positioned at an angle such that that when the drip guard 156 encounters the cushions of the docking station the force of the cushions causes the drip guard to flex upward and toward the rear of the transport vehicle 102 and away from the docking station. It should be understood that these are merely examples of how the drip guard 156 may be attached and these examples should not be considered limiting.

Because the cabinet system 100 is affixed to the rear surface of the transport vehicle 102 and not built into or partially built into the body of the transport vehicle 102 (like most pump cabinets in the industry), the cabinet system 100 must be manufactured to independently support the weight of the equipment to be contained within the cabinet system 100 and have sufficient structure and rigidity to maintain the sanitary requirements of the 3-A standards discussed above and to withstand the forces exerted onto the cabinet system during the docking process. While actual loads on the cabinet system 100 and forces exerted during the docking process may vary, in an embodiment, the cabinet system 100 is capable of handling up to 1500 pounds of equipment, the top surface 120 of the pump compartment 104 is capable of withstanding up to 500 pounds of equipment load, and the pump compartment 104 (including the dock mating surface) is capable of withstanding forces in excess of 5,000 pounds of force. Accordingly, the pump compartment 104 and pump compartment doors 144 must be manufactured to have sufficient rigidity and structure to comply with the pump compartment sealing requirements of 3-A standards and to not be damaged by the compression cushions when the dock mating surface 134 mates with a docking station.

Examples of sufficiently constructed pump compartment door(s) 144 are shown in FIGS. 8A, 8B, and 8C. Referring to FIG. 8A, in this example, the pump compartment door(s) 144 are reinforced with an internal panel 148 for at least the portion of the door that covers the interior opening of the pump compartment 104 and the interior frame edges 140 of the dock mating surface 134. The internal panel 148 provides additional rigidity and support for the pump compartment doors 144, without increasing the weight of the pump compartment doors 144 too much. The internal panel 148 is fully removable and cleanable to comply with 3-A standards. It should be understood that the internal panel 148 portion of the pump compartment doors 144 may vary from covering the entire surface area of the pump compartment doors 144 to not including a double internal panel 148 portion at all depending on the desired rigidity and weight restrictions for the pump compartment doors 144.

In addition, as shown in FIG. 8, the pump compartment doors 144 may include a double seal to aid in complying with 3-A standards: a primary seal 150 and a secondary seal 152. The primary seal 150 may be positioned on the interior surface of the pump compartment door(s) 144 to form a perimeter seal of the interior frame edges 140 of the dock mating surface 134 when in the closed position. In an embodiment, the primary seal 150 may correspond to the internal panel 148 of the pump compartment door(s) 144 such that the primary seal 150 is positioned on the edges of the internal panel 148. The secondary seal 152 may be positioned around the outer perimeter of the interior of the pump compartment door(s) 144 to create a seal between the interior surface of the pump compartment door(s) 144 and the exterior frame edges 142 of the dock mating surface 134 when the door(s) are in a closed position. The primary seal 150 and secondary seal 152 may be made of any material known for sealing purposes that comply with 3-A standards.

Referring to FIGS. 8B and 8C, in this example, the pump compartment door(s) are either fully reinforced with an internal panel (not shown) for the entire door or are not reinforced at all with an internal panel. The pump compartment door(s) are designed to fit just inside the interior frame edges 140 of the dock mating surface 134 with a primary seal 150 positioned around the perimeter of the pump compartment door(s) 144 to seal with the interior frame edges 140 of the dock mating surface 134 when in the closed position. The primary seal 150 may be made of any material known for sealing purposes that comply with 3-A standards.

Referring to FIGS. 6 and 7, structural support panels 154 may be added to the inward facing side of the dock mating surface 134 to provide additional rigidity and support for the dock mating surface when docking. The structural support panels 154 may be added to the sides, top, and/or bottom of the inward facing side of the dock mating surface 134 and may extend toward the rear of the transport vehicle 102 and either connect to the rest of the cabinet system 100 or to the rear surface of the transport vehicle 102.

Referring to FIG. 9, in an embodiment, the pump 136 may be mounted to the top surface 120 of the pump compartment 104. To support the weight of the pump 136, the top surface 120 of the pump compartment 104 may be reinforced by attaching an upward facing perimeter lip 158 around the perimeter of the top surface 120 of the pump compartment and attaching vertical structural supports 160 that run along the length and/or width of the top surface 120 and attach to the perimeter lip 158. This reinforces the strength of the top surface 120 without adding too much weight to the pump compartment 104.

### Motor Compartment 106:

Referring to FIGS. 5, 5A, 6 and 7, the motor compartment 106 is a substantially rectangular box shape cabinet. In an embodiment the motor compartment measures approximately 28″ wide by 24″ tall by 21″ deep. The motor compartment 106 houses the motor 138 and other controls for the pump 136, which, per the 3-A standard must be contained in a compartment separate from the equipment stored in the pump compartment 104. The motor compartment 106 is configured to be affixed (removably or permanently) to one side of the pump compartment 104. It should be understood that the above sizes for the motor compartment are merely exemplary and different sizes are contemplated. The cabinet system 100 is structured to be modular such that different sized compartments are contemplated. The height of the motor compartment 106 is completely adjustable (provided the motor fits) and the width is only constrained by the chassis width of the transport vehicle 102 and the width of the pump compartment 104. Further, the depth of the motor compartment 106 is only constrained by the depth of the pump compartment 104.

In general, the motor compartment 106 includes a top surface 170, a bottom surface 171 substantially parallel to the top surface, two substantially parallel side surfaces: a pump side surface 172 and an outside side surface 173 substantially perpendicular to the top surface 170 and bottom surface 171, an inward facing surface 174, and an outward facing surface 175 forming a rectilinear shaped cabinet. The top surface 170, bottom surface 171, inward facing surface 174, pump side surface 172 and outside side surface 173 are primarily solid panels or sheets of material permanently joined together to form the shape of a substantially rectangular box in compliance with the A-3 standards. Each surface may be an individual panel joined to the other panels or may be a one or more panels bent and joined at seams to form the prescribed shape.

As shown in FIGS. 6 and 9, the depth of the motor compartment 106 is less than the depth of the pump compartment 104 to allow for proper opening of the pump compartment door(s) 144 and to prevent the motor compartment 106 from interfering with the docking process. This depth may vary depending on the desired size of the motor compartment 106 and the size of the pump compartment 104. At minimum the motor compartment must be sufficiently less depth than the pump compartment 104 to allow for the pump compartment doors to open sufficiently for docking. In an embodiment, the motor compartment 106 should be at least 1 inch less in depth than the pump compartment 104 and further towards the rear of the transport vehicle 102 than the outward facing surface 130 of the pump compartment 104. This distance will keep the structure of the motor compartment 106 from interfering with the full opening of the pump compartment doors 144 and from interfering with the docking process. It should be understood that this is merely an exemplary distance, and a sufficient distance may be as little as nearly flush with the pump compartment 104. It should further be understood that a sufficient distance would be a minimum distance to provide the needed clearance for the docking process; however, in embodiments the distance could be greater.

The inward facing surface 174 may be flat, bent or curved to mimic and accommodate for the shape of the rear surface of the transport vehicle 102 or to mimic the shape of the inward facing surface 128 of the pump compartment. The inward facing surface 174 of the motor compartment 106 may be attached to the inward facing surface 128 of the pump compartment 104 on the edge that the two surfaces share. In an embodiment, the inward facing surface 174 of the motor compartment 106 and the inward facing surface 128 of the pump compartment 104 may be a singular surface that spans both the pump compartment 104 and the motor compartment 106. The inward facing surface 174 of the motor compartment 106 may be attached and affixed to the rear surface of the transport vehicle 102 in a permanent or semi-permanent manner.

The outside side surface 173 will be shaped and structured to join with the shape of the inward facing surface 174 of the motor compartment 106. The pump side surface 172 will be shaped and structured to join with the shape of the inward facing surface 174. The pump side surface 172 may have a hole bore in it for attaching the motor 138 (which is contained in the motor compartment 106) to the pump 136 (which is contained in the pump compartment 104). The hole in the pump side inward facing surface 174 aligns with the hold in the side surface (124 or 126) of the pump compartment 104. Further, the pump side surface 172 may include a pulley shroud 178 (or other protective shroud) inside the motor compartment 106 to protect the operator from moving parts of the motor 138. The pulley shroud 178 is parallel to the pump side surface 172 and may be removable. The pump compartment 104 and motor compartment 106 are sealed around the motor 138 and pump 136 connection point. The pump side surface 172 is affixed and attached to the side surface (124 or 126) of the pump compartment 104 on the same side where the pump 136 is situated. The pump side surface 172 may be releasably or permanently attached. In an embodiment the pump side surface 172 is not panel of material, but instead uses the side surface (124 or 126) of the pump compartment 104 as the pump side surface 172 of the motor compartment 106.

The outward facing surface 175 of the motor compartment 106 is substantially open for access to the interior of the motor compartment 106 and includes motor compartment door(s) 177. The outward facing surface 175 of the motor compartment 106 may include a panel that frames the interior of the motor compartment 106 such that the surface is substantially open to the interior of the motor compartment 106. In another embodiment, the outward facing surface 175 of the motor compartment 106 is completely open and only includes motor compartment door(s) 177 covering the outward facing surface 175. The outward facing surface 175 of the motor compartment 106 is positioned a distance between the outward facing surface 130 of the pump compartment 104 and the rear surface of the transport vehicle 102 such that the outward facing surface 175 of the motor compartment 106 does not interfere with the full opening of the pump compartment door(s) 144 and does not interfere with the docking process. This distance may vary based on cabinet system 100 configurations as discussed above.

The motor compartment door(s) 176 is/are primarily rectangular in shape and, when in the closed position, completely cover and seal the interior of the motor compartment 106 to meet 3-A standards as stated above. When in the open position, the motor compartment door(s) 176 provide access to the interior of the motor compartment 106. The motor compartment door(s) 176 is/are attached to the motor compartment 106 in any manner commonly known.

The top surface 170 of the motor compartment 106 may or may not have a drip guard 156 movably attached. The drip guard 156 (if included with the motor compartment 106) may be separate from the drip guard 156 for the pump compartment 104 or may be a continuation of the drip guard 156 for the pump compartment 104. The drip guard 156 for the motor compartment will be attached to the top surface 170 of the motor compartment 106 and operate in the same manner as the drip guard 156 for the pump compartment 104. The top surface 170 of the motor compartment 106 may be a separate panel from the top surface 120 of the pump compartment. In an embodiment, the top surface 170 of the motor compartment may be the same panel as the top surface 120 of the pump compartment 104 such that the top surface 170 of the motor compartment 106 is an extension of the top surface 120 of the pump compartment 104.

The motor 138 may be mounted to the top surface 170 of the motor compartment 106. To support the weight of the motor 138, the top surface 170 of the motor compartment 106 may be reinforced in a similar manner as the top surface 120 of the pump compartment 104. This can be achieved whether the surfaces are separate surfaces or a joint surface.

### Other Compartments 108:

Referring to FIGS. 5B, 6 and 7, the other compartment(s) 108 is/are a substantially rectangular box shape cabinet. In an embodiment, the other compartment 108 measures approximately 28″ wide by 24″ tall by 21″ deep but can be of varying dimensions. In an embodiment, an other compartment 108 may substantially resemble and be structured similar to the motor compartment 106. However, the other compartment 108 does not require a hole bore into any of the side surfaces 182 or 183 (only the outside side surface is shown in the images, but it should be understood that the pump side surface 172 of the motor compartment 106 will be substantially similar to the interior side surface of the other compartment 108). In this embodiment, the other compartment 108 is configured to be affixed (removably or permanently) to the side of the pump compartment 104 that is not affixed to the motor compartment 106. It should be understood that the above sizes for the other compartment(s) 108 are merely exemplary and different sizes are contemplated. The cabinet system 100 is structured to be modular such that different sized compartments are contemplated. The height of the other compartment(s) 108 is completely adjustable and the width is only constrained by the chassis width of the transport vehicle 102 and the width of the pump compartment 104 (and optional motor compartment 106). Further, the depth of the other compartment(s) 108 is only constrained by the depth of the pump compartment 104.

In general, the other compartment 108 includes a top surface 180, a bottom surface 181 substantially parallel to the top surface, two substantially parallel side surfaces 182 and 183 substantially perpendicular to the top surface 180 and bottom surface 181, an inward facing surface 184, and an outward facing surface 185 forming a rectilinear shaped cabinet. The top surface 180, bottom surface 181, inward facing surface 184, and side surfaces 182 and 183 are primarily solid panels or sheets of material permanently joined together to form the shape of a substantially rectangular box. Each surface may be an individual panel joined to the other panels or may be a one or more panels bent and joined at seams to form the prescribed shape.

As shown in FIGS. 6 and 7, the depth of the other compartment 108 is less than the depth of the pump compartment 104 to allow for proper opening of the pump compartment door(s) 144 and to prevent the other compartment 108 from interfering with the docking process. This depth may vary depending on the desired size of the other compartment 108 and the size of the pump compartment 104. At minimum the other compartment(s) 108 must be sufficiently less depth than the pump compartment 104 to allow for the pump compartment doors to open sufficiently for docking. In an embodiment, the other compartment 108 should be at least 1 inch less in depth than the pump compartment 104 and further towards the rear of the transport vehicle 102 than the outward facing surface 130 of the pump compartment 104. This distance will keep the structure of the other compartment 108 from interfering with the full opening of the pump compartment doors 144 and from interfering with the docking process. It should be understood that this is merely an exemplary distance, and a sufficient distance may be as little as nearly flush with the pump compartment 104. It should further be understood that a sufficient distance would be a minimum distance to provide the needed clearance for the docking process; however, in embodiments the distance could be greater.

The inward facing surface 184 may be flat, bent or curved to mimic and accommodate for the shape of the rear surface of the transport vehicle 102 or to mimic the shape of the inward facing surface 128 of the pump compartment 104. The inward facing surface 184 of the other compartment 108 may be attached to the inward facing surface 128 of the pump compartment 104 on the edge that the two surfaces share in embodiments where they share a surface. In an embodiment, the inward facing surface 184 of the other compartment 108 and the inward facing surface 128 of the pump compartment 104 may be a singular surface that spans both the pump compartment 104 and the other compartment 108 (and optionally the motor compartment 106). The inward facing surface 184 of the other compartment 108 may be attached and affixed to the rear surface of the transport vehicle 102 in a permanent or semi-permanent manner.

It should be understood that the side surfaces 182 and 183 of the other compartment 108 will be shaped and structured to join with the shape of the inward facing surface 184. The side surfaces 182 and 183 may be attached to any adjacent surfaces or may incorporate any adjacent surfaces as the side surface 182 or 183 of the other compartment 108.

The outward facing surface 185 of the other compartment 108 is substantially open for access to the interior of the other compartment 108 and may or may not include other compartment door(s) 186.

The outward facing surface 185 of the other compartment 108 is substantially open for access to the interior of the other compartment 108 and may or may not include other compartment door(s) 186. The outward facing surface 185 of the other compartment 108 may include a panel that frames the interior of the other compartment 108 such that the surface is substantially open to the interior of the other compartment 108. In another embodiment, the outward facing surface 185 of the other compartment 108 may be completely open and may or may not include other compartment door(s) 186 covering the outward facing surface 185. The outward facing surface 185 of the other compartment 108 is positioned a distance between the outward facing surface 130 of the pump compartment 104 and the rear surface of the transport vehicle 102 such that the outward facing surface 185 of the other compartment 108 does not interfere with the full opening of the pump compartment doors 144 and does not interfere with the docking process. This distance may vary based on cabinet system 100 configurations as discussed above.

In embodiments with other compartment door(s) 186, the other compartment door(s) 186 is/are primarily rectangular in shape and, when in the closed position, completely cover and seal the interior of the other compartment 108. When in the open position, the other compartment door(s) 186 provide access to the interior of the other compartment 108. The other compartment door(s) 186 is/are attached to the other compartment 108 in any manner commonly known.

In embodiments where the other compartment 108 is positioned at the top of the cabinet system, the top surface 180 of the other compartment 108 may or may not have a drip guard 156 movably attached. The drip guard 156 (if included with the other compartment 108) may be separate from the drip guard 156 for the pump compartment 104 or may be a continuation of the drip guard 156 for the pump compartment 104 (and optionally for the motor compartment 106). The drip guard 156 for the motor compartment will be attached to the top surface 180 of the other compartment 108 and operate in the same manner as the drip guard 156 for the pump compartment 104. The top surface 180 of the other compartment 108 may be a separate panel from the top surface 120 of the pump compartment. In an embodiment, the top surface 180 of the other compartment 108 may be the same panel as the top surface 120 of the pump compartment 104 such that the top surface 180 of the other compartment 108 is an extension of the top surface 120 of the pump compartment 104 (and optionally of the motor compartment 106).

The top surface 180 of the other compartment 108 may be reinforced in a similar manner as the top surface 120 of the pump compartment 104. This can be achieved whether the surfaces are separate surfaces or a joint surface.

It should be understood that there may be more than one other compartment 108 configured and affixed to the cabinet system 100 and the other compartments 108 may be of different configurations and sizes or there may be no other compartments 108. It should further be understood that the other compartments 108 will be attached to the cabinet system 100 by shared adjacent surfaces to the pump compartment 104, the motor compartment 106, and any additional other compartments 108. Further the other compartments 108 may share adjacent surfaces with the pump compartment 104, the motor compartment 106, and any additional other compartments 108 such that there is only one panel between the shared adjacent surfaces. For example, an other compartment 108 may be configured and attached to the bottom surface 171 of the motor compartment 106, or the bottom surface 181 of the first other compartment 108, or both.

It should also be understood that the 3-A standards apply to the pickup, transport, and delivery of milk. The cabinet system 100 may not be configured to be in full compliance with the 3-A standards when being used for purposes that do not require the compliance with 3-A standards, for example, juice, sugar syrups, oils, etc. However, regardless of the use and necessary standards, at minimum the cabinet system 100 will include a pump compartment 104 with a dock mating surface 134 covered by moveable pump compartment door(s) 144.

Directional terms, such as “top,” “upper,” “bottom,” “lower,” “outward,” “inward,” “end,” etc., are used for convenience in referring to the accompanying pictures. In general, the directional terms refer to a direction on the invention in relation to position and placement on the invention.

Any version of any component or method step of the invention may be used with any other component or method step of the invention. The elements described herein can be used in any combination whether explicitly described or not.

All combinations of method steps as used herein can be performed in any order, unless otherwise specified or clearly implied to the contrary by the context in which the referenced combination is made.

As used herein, the singular forms “a,” “an,” and “the” include plural referents unless the content clearly dictates otherwise.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

All patents, patent publications, and peer-reviewed publications (i.e., “references”) cited herein are expressly incorporated by reference in their entirety to the same extent as if each individual reference were specifically and individually indicated as being incorporated by reference. In case of conflict between the present disclosure and the incorporated references, the present disclosure controls.

The devices, methods, compounds and compositions of the present invention can comprise, consist of, or consist essentially of the essential elements and limitations described herein, as well as any additional or optional steps, ingredients, components, or limitations described herein or otherwise useful in the art.

While this invention may be embodied in many forms, what is described in detail herein is a specific preferred embodiment of the invention. The present disclosure is an exemplification of the principles of the invention, and it is not intended to limit the invention to the particular embodiments illustrated. It is to be understood that this invention is not limited to the particular examples, process steps, and materials disclosed herein as such process steps and materials may vary somewhat. It is also understood that the terminology used herein is used for the purpose of describing particular embodiments only and is not intended to be limiting, since the scope of the present invention will be limited to only the appended claims and equivalents thereof.

It is to be understood that the following claims are exemplary in nature only, and do not and should not be interpreted to place any limitations on any claims in any subsequent applications whatsoever.

This written description uses examples to disclose the invention, including the best mode, and also to enable any person skilled in the art to make anew the invention. Any dimensions or other size descriptions are provided for purposes of illustration and are not intended to limit the scope of the claimed invention. Additional aspects can include slight variations, as well as greater variations in dimensions as required for use in the industry. The patentable scope of the invention may include other examples that occur to those skilled in the art.

What is claimed is:

1. A cabinet system configured to affix or releasably affix to a rear surface of a transport vehicle with a rear outlet valve such that the rear outlet valve is encompassed and enclosed within a body of the cabinet system, the cabinet system comprising:
a pump compartment, including:
a top surface,
a bottom surface,
two substantially parallel opposing side surfaces, wherein one of the substantially parallel opposing side surfaces includes a side surface cutout to accommodate a pump connection to a motor in a motor compartment
a back surface with a cutout to accommodate the rear outlet valve of the transport vehicle, and
a front surface, including a dock mating face that is a substantially open frame providing access to an interior of the pump compartment, wherein the interior of the pump compartment is covered and sealed by a moveable pump compartment door that when open provides access to the interior of the pump compartment, further wherein the dock making face is configured to mate with a docking station; and
the motor compartment, including:
a top surface,
a bottom surface,
two substantially parallel opposing side surfaces, wherein one of the substantially parallel opposing side surfaces includes a cutout corresponding to the side surface cutout in the pump compartment to accommodate the pump connection to the motor in the motor compartment,
a back surface, and
a front surface, wherein the front surface of the motor compartment is substantially open to provide access to the interior of the motor compartment, further wherein the front surface of the motor compartment is covered and sealed by a moveable motor compartment door that when open provides access to the interior of the motor compartment;
wherein the motor compartment is affixed to one side surface of the pump compartment with the side surface cutout.

2. The cabinet system of claim 1, further comprising:
an other compartment, including:
a top surface,
a bottom surface,
two substantially parallel opposing side surfaces,
a back surface, and
a front surface, wherein the front surface of the other compartment is substantially open to provide access to the interior of the motor compartment, further wherein the front surface of the other compartment is covered and sealed by a moveable other compartment door that when open provides access to the interior of the other compartment;
wherein the other compartment is affixed to one for the two substantially parallel opposing side surfaces of the pump compartment.

3. The cabinet system of claim 2, wherein the other compartment is affixed to one of a top edge of one side surface of the pump compartment without the side surface cutout or the bottom surface of the motor compartment.

4. The cabinet system of claim 3, further comprising a second other compartment, wherein the second other compartment is affixed to one of a top edge of one side surface of the pump compartment without the side surface cutout, the bottom surface of the motor compartment, or the bottom surface of the other compartment.

5. The cabinet system of claim 1, wherein, when closed, the moveable pump compartment door seals the interior of the pump compartment pursuant to A-3 standards.

6. The cabinet system of claim 1, wherein the back surface of the pump compartment is configured to a shape of a back end of the transport vehicle and affixed to the back end of the transport vehicle.

7. The cabinet system of claim 1, wherein the dock mating face mates and seals with compression cushions of a shipping dock station in compliance with 3-A standards and PMO standards for docking stations.

8. The cabinet system of claim 1, further comprising a drip guard movably attached to a front edge of the top surface of the pump compartment and a front edge of the top surface of the motor compartment, wherein the drip guard overhangs the front surface of the front surface of the pump compartment and the front surface of the motor compartment when the cabinet system is not mated to a shipping dock station.

9. The cabinet system of claim 1, wherein the top surface of the pump compartment and the top surface of the motor compartment are reinforced, the reinforcement including an affixed upward extending lip around a perimeter of the top surface of the pump compartment and the top surface of the motor compartment and a plurality of attached vertical structural supports running along a length of the top surface of the pump compartment and the top surface of the motor compartment connecting to the affixed upward extending lip.

10. A cabinet system configured to affix or releasably affix to a rear surface of a transport vehicle with a rear outlet valve such that the rear outlet valve is encompassed and enclosed within a body of the cabinet system, the cabinet system comprising:
a pump compartment, including:
a top surface,
a bottom surface,
two substantially parallel opposing side surfaces,
a back surface with a cutout to accommodate the rear outlet valve of the transport vehicle, and
a front surface, wherein the front surface is an opening,
a dock mating face attached to the front surface of the pump compartment, wherein the dock making surface forms a substantially open frame providing access to an interior of the pump compartment, further wherein the dock making face is configured to mate with a docking station; and
a moveable pump compartment door attached to the dock mating face, wherein the interior of the pump compartment is covered and sealed by the moveable pump compartment door when closed and that when open provides access to the interior of the pump compartment.

11. The cabinet system of claim 10, further comprising:
A motor compartment, including:
a top surface,
a bottom surface,
two substantially parallel opposing side surfaces,
a back surface, and
a front surface, wherein the front surface of the motor compartment is substantially open to provide access to the interior of the motor compartment, further wherein the front surface of the motor compartment is covered and sealed by a moveable motor compartment door that when open provides access to the interior of the motor compartment;
wherein the motor compartment is affixed to one of the two substantially parallel opposing side surfaces of the pump compartment.

12. The cabinet system of claim 11, wherein one of the substantially parallel opposing side surfaces of the pump compartment includes a side surface cutout to accommodate a pump connection to a motor in the motor compartment, further wherein one of the substantially parallel opposing side surfaces of the motor compartment includes a side surface cutout corresponding to the side surface cutout of the pump compartment to accommodate the pump connection to the motor in the motor compartment.

13. The cabinet system of claim 11, further comprising:
an other compartment, including:
a top surface,
a bottom surface,
two substantially parallel opposing side surfaces,
a back surface, and
a front surface, wherein the front surface of the other compartment is substantially open to provide access to the interior of the motor compartment, further wherein the front surface of the other compartment is covered and sealed by a moveable other compartment door that when open provides access to the interior of the other compartment;
wherein the other compartment is affixed to one of the two substantially parallel opposing side surfaces of the pump compartment, further wherein the one of the two substantially parallel opposing side surfaces is the side surface which the motor compartment is not attached.

14. The cabinet system of claim 13, wherein the top surface of the pump compartment, the top surface of the motor compartment, and the top surface of the other compartment are a singular shared top surface spanning a top of the pump compartment, the motor compartment, and the other compartment.

15. The cabinet system of claim 14, further comprising a drip guard movably attached to a front edge of the singular shared top surface, wherein the drip guard overhangs the front surface of the pump compartment, the front surface of the other compartment, and the front surface of the motor compartment when the cabinet system is not mated to a shipping dock station.

16. The cabinet system of claim 14, wherein the singular shared top surface is reinforced, the reinforcement including an affixed upward extending lip around a perimeter of the singular shared top surface and a plurality of attached vertical structural supports running along a length of the singular shared top surface connecting to the affixed upward extending lip.

17. The cabinet system of claim 10, further comprising a drip guard movably attached to a front edge of the top surface of the pump compartment, wherein the drip guard overhangs the front surface of the pump compartment when the cabinet system is not mated to a shipping dock station.

18. The cabinet system of claim 10, wherein the top surface of the pump compartment reinforced, the reinforcement including an affixed upward extending lip around a perimeter of the top surface of the pump compartment and a plurality of attached vertical structural supports running along a length of the top surface of the pump compartment connecting to the affixed upward extending lip.

19. The cabinet system of claim 10, wherein when closed, the pump compartment door covers and seals both the interior of the pump compartment and the dock mating face.

20. The cabinet system of claim 13, further comprising a second other compartment, wherein the second other compartment is affixed to one of the bottom surface of the motor compartment or the bottom surface of the other compartment.
